(19) United States
(12) Patent Application Publication
(10) Pub. No.: US 2018/0014459 A1
(43) Pub. Date: Jan. 18, 2018

(54) ABSORBENT PRODUCTS AND METHODS FOR PRODUCING THE SAME

(71) Applicant: GY Labs, LLC, Las Vegas, NV (US)

(72) Inventor: Cory ROBERTS, Las Vegas, NV (US)

(21) Appl. No.: 15/647,545

(22) Filed: Jul. 12, 2017

Related U.S. Application Data
(60) Provisional application No. 62/361,231, filed on Jul. 12, 2016.

(51) Int. Cl. A01C 23/02; B01J 20/24; B01J 20/10; B01J 20/30; B01D 15/08

(52) U.S. Cl. CPC A01C 23/02; B01J 20/3028; B01D 15/08; B01J 20/10; B01J 20/24

(57) ABSTRACT

An absorbent product is useable as an absorbent material for cleaning spills or as a plant growth medium for improved moisture retention. A method includes processing a raw coir feedstock to pieces of a predetermined size and compressing the pieces at a predetermined temperature and pressure. The resulting pieces are cooled for a predetermined time to an ambient temperature and broken to a predetermined size. The resulting pieces are mixed with coir fines from the crumbling process at a predetermined ratio to form a final absorbent product.

### FIELD OF THE DISCLOSURE

This disclosure relates to absorbent products, particularly for use as absorbent pellets or a plant growth medium, and manufacturing methods for producing the same.

### BACKGROUND

Rising concerns about the environmental impact of consumer products have resulted in increasing interest in organic byproducts and methods for using them to replace existing products that may harm consumers or the environment.

One such harmful product is crystalline silica (silica), which is commonly used as an absorbent clay material (clay) and has recently been shown to have carcinogenic effects. Typically, cleaning spills of potentially hazardous oils and liquids has involved the manual application of clay absorbents to the spill. Clay absorbents are applied in a dry form that is prone to the creation of dust which may be inhaled by the consumer. The inhaled dust carries crystalline silica directly to a person's lungs and, as a carcinogenic material, can be severely detrimental to the person's health. The absorbent properties of the clay material are limited, and disposal of the clay after absorbing a hazardous spill can be expensive and may merely remove a dangerous material to a new area. There is a need for an improved absorbent material for cleaning spills of oil and other hazardous liquids.

Peat is a naturally occurring accumulation of partially decayed vegetation or organic matter, commonly formed from sphagnum moss (peat moss) in wetland conditions, and is highly absorbent. The absorbent properties of peat, with the advantageous effects of decaying organic matter, make it a useful soil amendment or soilless growth medium for agriculture. Peat has become one of the most common ingredients in plant growth media. However, the method of harvesting peat requires the destruction of the unique ecosystems where peat occurs, which function as some of the most efficient carbon sinks on Earth and provide many other important benefits to the surrounding environment. Although peat is often considered a renewable resource, it grows at only 1 mm per year and increasing demand for peat can cause permanent damage to peatlands. There is a need for improved ingredients in plant growth media.

The need for safer and environmentally friendly alternatives to clay absorbents and peat-based growth media have led to the identification of coir as a promising substitute. Coir is a byproduct of coconuts, typically composed of the remnants of the coconut husks and fibers from coconut processing. Coir is naturally occurring, organic, and highly absorbent, and the existing coconut industry produces large amounts of coir annually that is discarded. The absorbent properties, organic nature, and availability of coir have led to efforts to replace or supplement clay absorbents and peat with replenishable coir.

Different methods for the processing of coir as an absorbent material and a plant growth medium have emerged. U.S. Pat. No. 6,863,027 details the use of coir as a pelletized kitty litter. The pellets are formed by first grinding coconut shells to create coir pith and mixing the pith with water before compressing the mixture through a die. The resulting strings of coir pith are then cut and heated in an oven to remove moisture and harden the pellets. U.S. Pat. No. 8,256,160 teaches the use of coir as a plant growth medium by using a pre-seeded mixture of dehydrated bulking material, including coir, compressed with additional additives at a low temperature.

Despite these and other efforts, using coir in absorbent material and plant growth medium applications is relatively new and coir products have yet to sufficiently replace the capabilities of alternative materials. Known coir products frequently break apart during transport or during use and the resulting mixture can blow away or be more difficult to use, while attempts to provide more physically resilient coir products for convenient transport have failed to provide the required absorption characteristics.

Coir is also naturally inert, meaning that the material is inadequate for particular applications without additives, but certain additives in the coir may impair the absorbent properties of the material or the structural integrity of a pellet.

There is a need for coir-derived products to function at least as absorbent materials and plant growth media that combine proper absorption characteristics, physical resilience and robustness, and the ability to tolerate additives without comprising the absorption or resilience.

The present disclosure is directed to a coir pellet for use as an absorbent material or a plant growth medium with increased structural integrity and absorbency and a manufacturing process for producing the absorbent material. In the manufacturing process, advantageous uses of feedstock, moisture, heat and additives with the coir can be manipulated to create a more stable and effective final product. Higher absorbencies are also possible through an optimized pellet size and ratio of fines to pellets.

### SUMMARY

The present disclosure relates to absorbent products having improved absorbency and structural integrity, and methods for producing the same. The absorbent products are absorbent material for absorbing and disposing of spilled materials, and as plant growth media for encouraging plant growth and moisture retention. In use as an absorbent material or as plant growth media, the absorbent products may include at least one additive for increasing absorbency, promoting plant growth, or other beneficial characteristics.

A preferred method comprises an improved process for breaking pre-compressed feedstock into loose pieces of a first size, mixing the loose pieces with advantageous additives before heating, compressing and cooling the loose pieces into recompressed pieces of a second size, breaking the recompressed pieces into crumbles having a third size, separating the recompressed pieces from resulting fines, and assembling a mixture of crumbles and fines at a predetermined ratio. The resulting crumbles have improved absorbent properties and structural integrity.

Although not considered previously, using different materials as pre-compressed feedstock confers previously unrecognized advantages depending on the intended use of the crumbles. Coir materials having different levels of decomposition and pre-compression have not previously been recognized for showing any distinguishing characteristics when used as a feedstock for plant growth media, but have now been discovered to provide particular advantages depending on the intended use.

A feedstock material for a plant growth medium includes old coir, or coir composted prior to use in the method according to the present disclosure. Coir material allowed to compost for 3 to 18 months has been found to have a higher lignin content and does not continue to decompose. The old coir is less prone to harmful pathogens and microbes that may compete with a plant for nutrients, or cause shrinkage of the coir material due to decomposition after application as a plant growth medium. Materials including other coir materials and peat suffer from pathogens, microbes, and shrinkage.

Old coir also provides an improved feedstock material for an absorbent material, used for absorbing low viscosity spills or liquids not readily absorbed by existing coir products.

While the properties of the old coir are advantageous for a plant growth medium and with low viscosity spills, young coir, or coir not composted and is fresh in contrast to the aforementioned “old coir,” provides unexpected improvements in absorbency of high viscosity liquids. When tested against existing materials and the old coir, absorbent materials prepared with young coir exhibit a higher absorbency and faster absorption of high viscosity spills or liquids.

Advantages may be obtained with absorbent materials and plant growth media created from old and young coir when used at different levels of pre-compression. Pre-compressed feedstock having an original volume to pre-compressed volume ratio from 2:1 to 6:1 is preferred for the method of the current disclosure. A more compressed feedstock may be used for a plant growth medium and an absorbent material for low viscosity spills or liquids, while a less compressed feedstock is preferred for an absorbent material for use with high viscosity spills or liquids.

Because raw coir feedstock may comprise different sized pieces of coconut husk and fiber compressed together, the present method involves processing the raw coir feedstock using applied moisture, such as water, and a debaler designed to agitate, break and potentially decompress the raw feedstock. The resulting loose coir pieces of a first size allow for better recompression, resulting in coir crumbles having greater structural integrity and increased absorbing abilities.

Though previously unexpected, using applied moisture in the feedstock may be critical in particular applications of the current method. The moisture facilitates the breaking of the feedstock in the debaler but also enables improved uptake of additives and amendments throughout the loose pieces. The moisture also increases the efficacy of compression at elevated temperatures, by protecting the coir and forming a recompressed piece that is firm enough to hold together when handled but soft enough to readily break apart when absorbing a liquid without further treatment.

A surfactant may be applied during processing of the pre-compressed feedstock by a dosing unit, such that the surfactant is distributed within the loose pieces. Applying a surfactant to the loose pieces during decompression or breaking has been discovered to increase the efficiency of the debaler in processing the feedstock by increasing the distribution of moisture through the pre-compressed feedstock, and also results in a distribution of surfactant throughout the loose pieces and eventually the resulting crumbles. The surfactant decreases the time for liquids to penetrate within and through the crumbles, such that the speed and efficiency of the coir's absorbent properties are maximized. The surfactant is advantageous in a plant growth medium, as the lateral and vertical movement of water is increased in such a way it becomes more available to plant roots. Additional liquid additives may be provided by the dosing unit while the debaler processes the pre-compressed feedstock into the loose pieces of a first size to achieve similar advantages.

Dry additives may be mixed with the loose pieces in a mixer. The mixer agitates the loose pieces to facilitate an even distribution of additives such that the advantageous benefits of the additives may be realized throughout the crumbles.

A particular advantage is obtained by ensuring that the material has a predetermined moisture content prior to compression, which may be achieved by adding a conditioner including moisture to the loose pieces or through applying water to the pre-compressed feedstock as discussed previously. Although increased moisture was previously believed to negatively affect the potency of additives within the crumbles and the absorbency of the crumbles, it has been discovered that increased levels of moisture not only can preserve potency of additives during heating and compression, but also increases the structural integrity and absorbency of the crumbles. The increased moisture content is most significant when compressing using elevated temperatures, and also when using young coir feedstock. When processed below the predetermined moisture content the loose pieces are too dry, and cannot be sufficiently compacted and/or may be damaged in the elevated temperature of a pellet mill, and resulting in a less absorbent or otherwise less effective crumble. At the same time a moisture content above the predetermined level results in a weak crumble that does not have the required structural integrity to be packaged, transported and applied by a consumer.

The loose pieces may be exposed to elevated temperatures (as compared to ambient temperatures) during compression to recompressed pieces having a predetermined volume-to-volume ratio, followed by immediate cooling by forced air. Although previously believed to be potentially damaging to the coir and additives, elevated temperatures within a predetermined range during compression have been discovered to increase the structural integrity and absorbent properties of the crumbles, particularly when applied in combination with the moisture levels discussed previously and/or in combination with immediate cooling following compression. During compression, the elevated temperatures and pressures of the pellet mill force moisture out of the loose pieces and arrange the loose pieces into recompressed pieces of a second size with an enhanced matrix. The heat treatment increases the durability and absorption characteristics of the coir material and creates a more structurally sound crumble.

Temperatures outside of the identified range fail to provide the benefits described, as elevated temperatures (above at least ambient temperatures) and pressure may cause a hard shell to form that reduces the absorbent properties of the crumbles while low temperatures do not increase the durability and the absorption characteristics of the coir.

Immediately cooling the recompressed pieces following compression prevents the reintroduction of moisture and causes rapid compression of the exterior of the pellet, resulting in pellets with greater structural integrity and absorbent properties. One example of cooling conditions for the recompressed pieces are in a cooling unit by forced air, over a prescribed period and immediately following compression of the coir starting material. The cooling step forms part of the process described herein.

Another advantage of the present disclosure is the inclusion of fines with crumbles. After being cooled, the pellets are configured to a size range, having a preferred surface area to volume ratio for absorbency depending on the intended application, by a crumbling unit. Any resulting fines, or dust, falling from the recompressed pieces may be collected by a screening unit and reintroduced to the crumbles in a predetermined ratio or added to the loose pieces to prevent material loss. The smaller size and increased surface area of coir fines enables the crumbles/fines mixture to capture the totality of a liquid or oil spill without disadvantageous blowing dust, which can cause discomfort to the user and material loss. The ratio of fines to crumbles creates a mixture that clumps together and is easy to apply and recover for disposal.

The size of the crumbles can also influence the absorbency of the final mixture, and increase the ease of using the product. Crumbles that are too large have a reduced surface area and absorb liquids at a slower rate while small crumbles cannot hold as much liquid and are more difficult to handle due to the tendency to blow away or form dust. At a preferred size the crumbles are easy to apply and quickly absorb liquids.

The numerous other advantages, features and functions of embodiments of the absorbent products and the method for producing the same will become readily apparent and better understood in view of the following description and accompanying drawings.

### BRIEF DESCRIPTION OF THE DRAWINGS

The drawing figures are not necessarily drawn to scale, but instead are drawn to provide a better understanding of the method, and are not intended to be limiting in scope, but to provide exemplary illustrations. The figures illustrate exemplary configurations of a method and system for producing absorbent products, and in no way limit the configurations of a method according to the present disclosure.

FIG. 1 depicts a flow diagram of a method for producing absorbent products.

FIG. 2 is a schematic view showing a method according to a preferred embodiment for producing coir products.

FIG. 3 is a plan view of an embodiment of a coir pellet according to the disclosure.

### DETAILED DESCRIPTION OF VARIOUS EMBODIMENTS

A. Overview

A better understanding of different embodiments of the disclosure may be had from the following description read with the accompanying drawings in which like reference characters refer to like elements.

While the disclosure is susceptible to various modifications and alternative constructions, certain illustrative embodiments are in the drawings and are described below. It should be understood, however, there is no intention to limit the disclosure to the specific embodiments disclosed, but on the contrary, the intention covers all modifications, alternative constructions, combinations, and equivalents falling within the spirit and scope of the disclosure.

It will be understood that, unless a term is defined to possess a described meaning, there is no intent to limit the meaning of such term, either expressly or indirectly, beyond its plain or ordinary meaning.

Any element in a claim that does not explicitly state “means for” performing a specified function, or “step for” performing a function is not to be interpreted as a “means” or “step” clause as specified in 35 U.S.C. §112(f).

B. Embodiments of the Method for Producing Absorbent Products

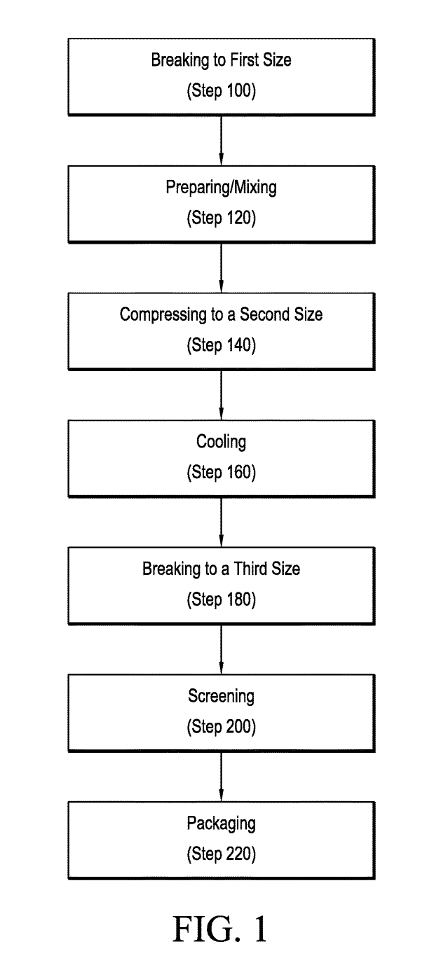

FIG. 1 depicts the method for producing an absorbent product for use as a plant growth medium or absorbent material.

In a first breaking step 100, pre-compressed feedstock is broken by a debaler while liquid amendments are incorporated using a dosing unit. The resulting loose pieces have a first size within a particular range and a mixture of liquid amendments throughout before proceeding to a preparation/mixing step 120. Different coir products can be used as feedstock, and may be preferred for application as an absorbent material or a plant growth medium.

Surfactant materials are advantageous when applied to the pre-compressed feedstock during the first breaking step 100. Applying surfactant materials to the pre-compressed feedstock increases the efficiency of the debaler and distributes surfactant throughout the loose pieces before compression. Surfactants reduce the surface tension of water and provide for both vertical and lateral movement of water through a plant growth medium. When water is applied to the plant growth medium, the surfactant ensures that channels open for passing water between the coir particles. By so doing, the surfactant helps the plant growth medium decompress efficiently and provides short-term rewetting benefits. In a similar way, surfactant materials may increase the speed and efficiency of absorbent material in cleaning liquid spills. Various surfactant materials may be used in the method, depending on the intended use and the liquid to be absorbed. Surfactant materials of the block copolymer type may be preferred for plant growth medium applications of the crumbles.

During the preparation/mixing step 120 the loose pieces may mix with any number of additional dry additives and preparation materials for compression, including conditioner materials for increasing moisture content, such that the loose pieces have a predetermined moisture level.

The compression step 140 forms the loose pieces into recompressed pieces of a second size at a predetermined temperature and pressure within a pellet mill. The resulting recompressed pieces are not limited to any shape, and may be discs, cylinders, flakes, etc.

The recompressed pieces may be cooled in a cooling step 160 before entering a second breaking step 180. The cooling step 160 may take place over a predetermined time sufficient to reduce the temperature of the pellets to an ambient temperature to increase absorbency and structural integrity properties of the recompressed pieces.

In the second breaking step 180 the recompressed pieces may break into crumbles of a preferred size range. Breaking the recompressed pieces may cause the creation of fines or dust. The crumbles and fines may be collected separately in a screening step 200.

In the packaging step 220 the fines may be mixed into the crumbles at a predetermined ratio, depending on the intended use, while any excess fines are recycled back into the preparation/mixing step 120. The final mixture contains 5-20% fines by weight, preferably about 5% in a plant growth medium and 10-20% for an absorbent material, which provides an increased surface area to volume ratio for the mixture without creating blowing dust. The mixture may be packaged into bags for shipment.

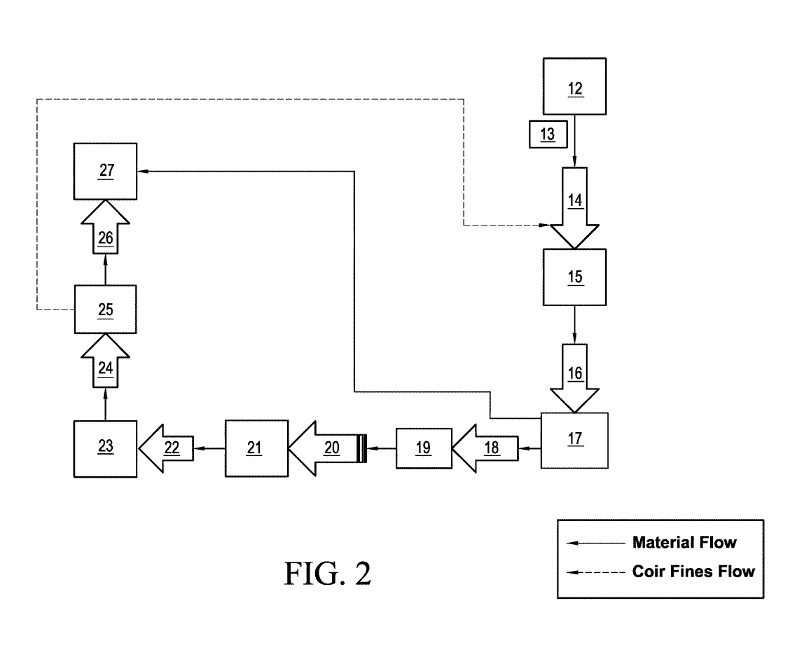

In FIG. 2, a preferred method for manufacturing absorbent products is illustrated. According to this embodiment, pre-compressed raw coir, as pre-compressed feedstock, is introduced to a debaler 12 configured to agitate the pre-compressed feedstock and to add moisture.

Raw coir is available in varying forms, both as loose pith and as compressed bricks or bags of coir. Using applied moisture and a debaler 12 the pre-compressed feedstock is broken into loose pieces having a first size, preferably within a range of 0.25 mm and 4.75 mm. Loose pieces of this size compact together more easily and provide for better absorbency and structural integrity of the end product than smaller or larger pieces.

According to one example, the method includes a dosing unit 13 for applying liquid amendments before and/or during the break down of the pre-compressed feedstock in the debaler 12.

In a preferred embodiment of the crumbles for use as a plant growth medium, a biodegradable blend of surfactant chemistries may be applied to compacted feedstock by the dosing unit 13 as it is broken down. During this initial break down of the feedstock, the surfactant spreads throughout the loose pieces and increases both vertical and lateral movement of water through the plant growth medium.

Distributing the surfactant within the coir enables the final plant growth medium to decompress more efficiently when water is applied. The surfactant creates a network of channels throughout the plant growth medium for the transport of water at an initial dampening, while also providing a future short-term rewetting benefit that is less expensive and more efficient than long-term surfactants absorbed into the coir for slow release. A similar benefit may also be realized in use as an absorbent material.

As the pre-compressed feedstock is broken into loose pieces it is transported by a screw auger 14, to an agitated feed bin 15 for feeding the coir starting material into a mixer 17. Using a screw auger 14, and agitated feed bin 15 keeps the loose pieces from forming clumps and retains an even distribution of additives or amendments before compression.

Additional liquid amendments may be added by the dosing unit 13 or the loose pieces may be mixed with additional dry additives in the mixer 17. The dry additives and liquid amendments can increase the strength of the pellets or to add fragrance, color, flammability, fertilizer, etc. depending on the intended use of the pellets. Preferred additives and amendments include combinations of the following: Sodium nitrate, dry super absorbent polymers, humic shale/leonardite, slow- and/or controlled-release fertilizers, worm castings, organic compost, molasses, neem, amorphous silica (ignimbrite), wollastonite (calcium silicate), liquid humic acid, fulvic acid, fractions of humic and fulvic acid, ferrous sulfate, triple super phosphate, calcium nitrate, magnesium sulfate, urea nitrogen, water insoluble nitrogen (urea-formaldehyde), Bacillus sp., Paenibacillus, Glomus sp., Trichoderma sp., Pseudomonas sp., Staphulococcus sp., Kocuria sp., Brevibacterium sp, Brevibacillus sp., Rhizobium sp. Amorphous silica may be a preferred additive, which contains a high amount of silicon dioxide (SiO₂). This additive improves plant quality by building stronger roots, stems and foliage while mitigating both biotic (insect/disease) and abiotic stresses (heat/cold). Slow- and controlled-release fertilizers may be configured to provide increased fertility over a time period ranging from 0 to 12 months. Super absorbent polymers may be included as a preferred additive to enable the resulting crumbles to retain additional water, as some super absorbent polymers can absorb over 100 times their weight. As an alternative embodiment, the loose pieces include no additives besides water.

For use as an absorbent material a microbe having activity regarding a particular material may be added, for example a microbe that breaks down oil may be added for absorbent materials intended for use cleaning oil spills.

After mixing and prior to compression, the loose pieces preferably have between 35% and 65% moisture content by weight, and preferably between 45% and 55% moisture content by weight where young coir feedstock is used. The high moisture levels are essential to the creation of recompressed pieces having higher absorbency and structural integrity, and also protect the coir and additives from damage due to heat. Below the predetermined moisture content the starting material is too dry, and cannot be sufficiently compacted or may be damaged in the elevated temperature of a pellet mill. At the same time a moisture content above the predetermined level results in wet recompressed pieces, that do not have the required structural integrity to be packaged, transported and applied by a consumer. If the material is too dry, a moisture containing conditioner can be added to the mixer 17. The loose pieces, including any additives and amendments, is transported to a pellet mill 19.

The pellet mill 19 compresses the loose pieces into recompressed pieces at a 3:1 to 8:1 loose piece volume to recompressed volume ratio, depending on the intended use. A greater compression ratio is advantageous for plant growth medium applications where the medium is more beneficial compacted to the roots and less prone to shrinkage in use, while a smaller ratio is preferred for an absorbent material where the ability to break apart and absorb liquid rapidly is the priority. The pellet mill operates while maintaining the coir at an elevated temperature, between 40° C. and 80° C., preferably between 45° C. and 55° C., and more preferably between 48° C. and 51° C., such that the coir is not damaged by heat and forms no hard shell, but is heat treated to increase the structural integrity and absorbent properties of the coir.

The resulting recompressed pieces exit the pellet mill at an elevated temperature and are transported to a cooling unit or cooler 21. In the preferred embodiment of FIG. 2, a bucket elevator 20 transports the recompressed pieces to the cooler 21, preferably within 2 minutes of leaving the pellet mill. The cooler 21 cools the recompressed pieces for about 5 minutes, at least until reaching ambient temperature, preferably by forced air or some other means, such that the recompressed pieces are rapidly brought from an elevated temperature to ambient temperature. If the recompressed pieces are not cooled following compression are left to cool by natural means, the recompressed pieces and crumbles are not as structurally resilient and can have moisture reintroduced from air or break apart in transport and/or use.

The cooled recompressed pieces may enter a crumbler 23 which may break the recompressed pieces to a length of 2-3 mm for the absorbent and 2-5 mm for the plant growth medium and produce coir fines. The resulting crumbles have a length L to diameter D ratio from 4:1 to 6:1 (L:D), for example a crumble may be 3 mm long and 0.5 mm in diameter. The crumbler 23 may comprise a roller mill.

The crumbler may be configured to produce fines, such that the density of the recompressed pieces is reduced to a mixture of crumbles and fines.

Either with the crumbler 23 or immediately following crumbler 23, the crumbles may optionally pass over a screener 25 which separates coir dust, or fines, from the crumbles. Rather than discarding the fines the screener collects and reintroduces them either to the agitated feedbin 15 with the loose pieces to prepare for compression or into the packaged product as a mixture with the crumbles. The fines remain with the crumbles without being separated.

A packaging machine 27 receives the crumbles and optionally the fines into bags and prepares them for shipping. If the bags include fines, the fines are combined with the crumbles at a ratio of 5-20% by weight, as described previously. The combination of fines and crumbles increases the absorbent properties of the mixture, particularly the speed of absorbing.

Throughout the method the coir material may be transported by any suitable means by a conveyor 16, 18, 22, 24, 26.

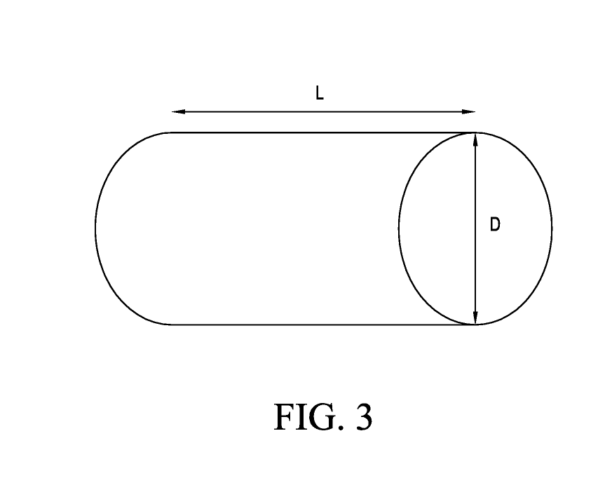

A preferred embodiment of a coir crumble is illustrated in FIG. 3. According to this embodiment the crumble may have a cylindrical shape, a length L and a diameter D. The length to diameter ratio of the pellet falls within the preferred range of 4:1 to 6:1 (L:D). A length to diameter ratio within this range creates a crumble with sufficient surface area to quickly absorb liquid while containing sufficient volume to efficiently saturate the coir. When a pellet is too long it may be prone to breaking and creating dust, while pellets that are too thick will absorb liquid too slowly and/or stay dry in the center. The particular embodiment in FIG. 3 is well-suited for use as an absorbent material.

Using an absorbent material composed of coir crumbles according to the current disclosure is advantageous because of the ability of the crumbles to absorb up to nine times their weight in fluids such as motor oil, gasoline, transmission fluid, antifreeze, and etc. The crumbles may be configured to better absorb liquids of high or low viscosity by altering the original volume to pre-compressed volume compression ratio of the pre-compressed feedstock or the additives and amendments. A compression ratio between 2:1 and 6:1 of feedstock and of 3:1 to 8:1 of recompressed pieces are preferred as the compression preserves the natural absorbent properties of the coir microstructure while increasing the efficiency of application, delivering more coir to a smaller area.

In crumble form the coir is ideal for application to any spill. The crumbles may be placed by hand or otherwise applied. Although the absorbent crumbles may break apart when introduced to fluids, the coir clumps together providing for easy disposal or reuse. Depending on saturation and usage, the crumbles may also be reused over four times before disposal is necessary.

Alternative embodiments of a crumble include a crumble shaped as a disc, sphere, pyramid, flake, etc. Different embodiments may be configured for different uses.

When used as a plant growth medium the compressed coir crumbles can be used as, but are not limited to, a soil conditioner for water retention, or for aeration.

Mixtures of compressed coir crumbles and fines that include surfactant materials are beneficial as a plant growth medium. As previously indicated, at the first dampening of the crumbles and fines the surfactant reacts with the water to create a network of lateral and vertical channels throughout the mixture. These channels provide efficient passage of water and air to the root structure of plants, both decreasing the maintenance required and increasing the health of the plants.

A preferred embodiment may include a mixture of irregularly shaped pellets combined with additives such as nutrients, minerals and microbial activity configured to provide a healthy environment for plants. The growing medium is suited to application in home gardening (for example 10 lbs per 1,000 square feet), under trees and shrubs (for example 2 oz per tree or shrub), for seeding and greenhouse growth (for example as 7 to 10% of total soil) and for large-scale applications (for example 100 lbs per acre applied every 2 years). Applied to sand or clay environments the growing medium also retains water in the soil while preventing overwatering and can reduce water use.

The disclosure presents an improvement in the use and manufacture of absorbent products for absorbent purposes and plant growth media, by improving upon both structural properties and absorption characteristics while allowing advantageous use of additives configured to various uses.

It is to be understood that not necessarily all objects or advantages may be achieved under any embodiment of the disclosure. For example, those skilled in the art will recognize that absorbent products and methods for producing the same may be embodied or carried out in a manner that achieves or optimizes one advantage or group of advantages as taught herein without necessarily achieving other objects or advantages as may be taught or suggested herein.

The skilled artisan will recognize the interchangeability of various disclosed features. Besides the variations described, other known equivalents for each feature can be mixed and matched by one of ordinary skill in this art to construct an assembled structure comprising stackable layers under principles of the present disclosure.

1. A method for production of an absorbent material, comprising the steps of:
providing a pre-compressed feedstock material;
applying moisture to the pre-compressed feedstock material;
breaking the pre-compressed feedstock material into loose pieces having a first size in a debaler;
compressing the loose pieces into recompressed pieces having a second size, wherein the loose pieces are compressed at a predetermined elevated temperature;
cooling the recompressed pieces within a predetermined period to an ambient temperature in a cooler; and
processing the recompressed pieces in an absorbent product.

2. The method according to claim 1, wherein the pre-compressed feedstock material comprises young coir that has not substantially decomposed from fresh coir.

3. The method according to claim 1, wherein the pre-compressed feedstock material comprises old coir that has substantially decomposed from fresh coir for a predetermined period.

4. The method according to claim 1, wherein during the step of breaking the pre-compressed feedstock material, a surfactant is added to the pre-compressed feedstock material by a dosing unit.

5. The method according to claim 1, wherein prior to the step of compressing the loose pieces the loose pieces are mixed with amorphous silica.

6. The method according to claim 1, wherein the step of compressing the loose pieces comprises compressing the loose pieces in a pellet mill.

7. The method according to claim 6, wherein during the step of compressing the loose pieces, the recompressed pieces reach an elevated temperature between 40° C. and 80° C.

8. The method according to claim 1, wherein the pre-compressed feedstock material is pre-compressed at a 3:1 to 6:1 original volume to pre-compressed volume ratio.

9. The method according to claim 3, wherein the step of compressing the loose pieces into recompressed pieces comprises compressing the loose pieces to a 2:1 to 8:1 loose piece volume to recompressed volume ratio.

10. The method according to claim 1, wherein the step of crumbling the recompressed pieces into crumbles and fines comprises crumbling the recompressed pieces into crumbles having a length to diameter ratio of 4:1 to 6:1.

11. The method according to claim 1, wherein prior to the step of compressing the loose pieces the loose pieces have a moisture content of 35% to 65% by weight.

12. The method according to claim 1, wherein the step of crumbling the recompressed pieces into crumbles and fines comprises crumbling the recompressed pieces such that a resulting mixture of crumbles and fines is 5% to 20% fines by weight.

13. The method according to claim 12, wherein the resulting mixture of crumbles and fines is screened by passage over a screener and the fines are separated from the crumbles.

14. The method according to claim 1, wherein prior to the step of compressing the loose pieces, the loose pieces are mixed with a dry super absorbent polymer.

15. The method according to claim 1, wherein the step of cooling the recompressed pieces within a predetermined period to an ambient temperature in a cooler comprises cooling the recompressed pieces to ambient temperature.

16. The method according to claim 3, wherein the old coir has decomposed through composting for a predetermined period of 3 to 18 months such that the old coir does not further shrink or decompose.

17. The method according to claim 2, wherein prior to the step of compressing the loose pieces, the loose pieces have a moisture content of 45% to 55% by weight.

18. The method according to claim 1, wherein the step of crumbling the recompressed pieces into crumbles and fines comprises crumbling the recompressed pieces to a length of 2-5 mm.

19. An absorbent product comprising a mixture of compressed young coir pieces and coir fines, wherein the mixture comprises 10% to 20% fines by weight.

20. A method for the production of an absorbent material, comprising the steps of:
providing a pre-compressed feedstock material comprising at least coir compressed from an original volume to compressed volume ratio of 3:1 to 6:1;
applying moisture to the pre-compressed feedstock such that the feedstock includes 35% to 65% moisture by weight;
breaking the wet pre-compressed feedstock material into loose pieces having a first size in a debaler;
compressing the loose pieces into recompressed pieces having a second size, wherein the loose pieces are compressed such that the loose pieces reach an elevated temperature between 45° C. and 55° C.;
cooling the recompressed pieces within a predetermined amount of time to an ambient temperature in a cooler; and
crumbling the recompressed pieces into a mixture comprising crumbles and fines, such that the mixture comprises 5% to 20% fines by weight.
